(19) United States
(12) Patent Application Publication
(10) Pub. No.: US 2018/0054449 A1
(43) Pub. Date: Feb. 22, 2018

(54) Methods and Systems for Protecting Computing Devices from Non-Benign Software Applications via Collaborative Application Detonation

(71) Applicant: QUALCOMM Incorporated, San Diego, CA (US)

(72) Inventors: Sriram Nandha Premnath, San Jose, CA (US); Yin Chen, Campbell, CA (US); Saumitra Mohan Das, San Jose, CA (US); Nayeem Islam, Palo Alto, CA (US)

(21) Appl. No.: 15/240,721

(22) Filed: Aug. 18, 2016

(51) Int. Cl. H04L 29/06; G06F 21/56

(52) U.S. Cl. CPC H04L 63/145; G06F 2221/033; G06F 21/566

(57) ABSTRACT

A network and its devices may be protected from non-benign behavior, malware, and cyber attacks by configuring a server computing device to work in conjunction with a multitude of client computing devices in the network. The server computing device may be configured to receive data that was collected from independent executions of different instances of the same software application on different client computing devices. The server computing device may combine the received data, and use the combined data to identify unexplored code space or potential code paths for evaluation. The server computing device may then exercise the software application through the identified unexplored code space or identified potential code paths in a client computing device emulator to generate analysis results, and use the generated analysis results to determine whether the software application is non-benign.

### BACKGROUND

Cellular and wireless communication technologies have seen explosive growth over the past several years. Wireless service providers now offer a wide array of features and services that provide their users with unprecedented levels of access to information, resources and communications. To keep pace with these enhancements, consumer electronic devices (e.g., cellular phones, watches, headphones, remote controls, etc.) have become more powerful and complex than ever, and now commonly include powerful processors, large memories, and other resources that allow for executing complex and powerful software applications on their devices. These devices also enable their users to download and execute a variety of software applications from application download services (e.g., Apple® App Store, Windows® Store, Google® play, etc.) or the Internet.

Due to these and other improvements, an increasing number of mobile and wireless device users now use their devices to store sensitive information (e.g., credit card information, contacts, etc.) and/or to accomplish tasks for which security is important. For example, mobile device users frequently use their devices to purchase goods, send and receive sensitive communications, pay bills, manage bank accounts, and conduct other sensitive transactions. Due to these trends, mobile devices are becoming the next frontier for malware and cyber attacks. Accordingly, new and improved security solutions that better protect resource-constrained computing devices, such as mobile and wireless devices, will be beneficial to consumers.

### SUMMARY

Various embodiments include methods of protecting client computing devices on a network from non-benign software applications that may be implemented on a server computing device. Various embodiments may include receiving data collected from independent executions of different instances of the same software application on different client computing devices and combining the received data. Various embodiments may further include using the combined data to identify unexplored code space or potential code paths for evaluation, exercising the software application through the identified unexplored code space or identified potential code paths in a client computing device emulator to generate analysis results, and using the generated analysis results to determine whether the software application is non-benign.

In some embodiments, receiving data collected from independent executions of different instances of the same software application on different client computing devices may include receiving data for multiple software applications. Such embodiments may further include computing a rank value for each of the software applications, and selecting one of the software applications for evaluation based on its corresponding rank value.

Some embodiments may further include using the received data to determine, for each of a plurality of activities associated with a software application, first conditional probability distribution values for different numbers of suspicious behaviors with respect to a condition in which an activity is visited, using the received data to determine, for each of the plurality of activities associated with the software application, second conditional probability distribution values for different numbers of suspicious behaviors with respect to a condition in which an activity is not visited. Such embodiments may further include computing a distance value based on the determined first and second conditional probability distribution values for each of a plurality of activities associated with a software application, and selecting an activity for evaluation based on the magnitude of the computed distance value.

In some embodiments, exercising the software application through the identified unexplored code space or identified potential code paths in a client computing device emulator to generate analysis results may include cycling the software application through different location and time settings via the client computing device emulator. Some embodiments may further include determining a code coverage score and/or ranking score for the software application. Some embodiments may further include determining an overall risk score for the software application. Some embodiments may further include determining whether the received data is sufficient to evaluate the software application, and sending feedback information to the client computing devices that indicates that no additional data is needed from specific group of users in response to determining that the received data is sufficient to evaluate the software application.

Various embodiments include a server computing device including a network access port and a processor configured with processor-executable instructions to perform operations of the methods summarized above. Various embodiments also include a server computing device having means for performing functions of the methods summarized above. Various embodiments also include a non-transitory processor-readable medium on which is stored processor-executable instructions configured to cause a processor of a server computing device to perform operations of the methods summarized above.

### BRIEF DESCRIPTION OF THE DRAWINGS

The accompanying drawings, which are incorporated herein and constitute part of this specification, illustrate exemplary embodiments of the invention, and together with the general description given above and the detailed description given below, serve to explain the features of the invention.

FIG. 1 is a communication system block diagram illustrating network components of an example telecommunication system that is suitable for use with various embodiments.

FIG. 2 is a block diagram illustrating example logical components and information flows in a system that includes a detonator component in accordance with various embodiments.

FIGS. 3A and 3B are block diagrams illustrating example logical components and information flows in an embodiment system configured to protect a corporate network or client computing devices from malware and other non-benign applications or behaviors in accordance with various embodiments.

FIG. 4A is an illustration of a joint coverage table that is suitable for use in protecting a corporate network or client computing devices from malware and other non-benign applications or behaviors in accordance with an embodiment.

FIG. 4B is an illustration of an activity graph that is suitable for use in protecting a corporate network or client computing devices from malware and other non-benign applications or behaviors in accordance with an embodiment.

FIG. 5 is an illustration of another joint coverage table that is suitable for use in protecting a corporate network or client computing devices from malware and other non-benign applications or behaviors in accordance with another embodiment.

FIG. 6 is an illustration of another joint coverage table that is suitable for use in protecting a corporate network or client computing devices from malware and other non-benign applications or behaviors in accordance with another embodiment.

FIG. 7 is a block diagram illustrating additional components and information flows in an embodiment system that is configured to protect a corporate network and associated devices in accordance with various embodiments.

FIG. 8A is a process flow diagram illustrating a method for protecting client devices in accordance with an embodiment.

FIG. 8B is a process flow diagram illustrating a method for protecting client devices in accordance with another embodiment.

FIG. 9 is a component block diagram of a client computing device suitable for use with various embodiments.

FIG. 10 is a component block diagram of a server device suitable for use with various embodiments.

### DETAILED DESCRIPTION

The various embodiments will be described in detail with reference to the accompanying drawings. Wherever possible, the same reference numbers will be used throughout the drawings to refer to the same or like parts. References made to particular examples and implementations are for illustrative purposes, and are not intended to limit the scope of the invention or the claims.

Phrases such as “performance degradation,” “degradation in performance” and the like may be used in this application to refer to a wide variety of undesirable operations and characteristics of a network or computing device, such as longer processing times, slower real time responsiveness, lower battery life, loss of private data, malicious economic activity (e.g., sending unauthorized premium short message service (SMS) message), denial of service (DoS), poorly written or designed software applications, malicious software, malware, viruses, fragmented memory, operations relating to commandeering the device or utilizing the device for spying or botnet activities, etc. Also, behaviors, activities, and conditions that degrade performance for any of these reasons are referred to herein as “not benign” or “non-benign.”

The terms “client computing device,” and “mobile computing device,” are used generically and interchangeably in this application, and refer to any one or all of cellular telephones, smartphones, personal or mobile multi-media players, personal data assistants (PDA's), laptop computers, tablet computers, smartbooks, ultrabooks, palm-top computers, wireless electronic mail receivers, multimedia Internet enabled cellular telephones, wireless gaming controllers, and similar electronic devices which include a memory, a programmable processor for which performance is important, and operate under battery power such that power conservation methods are of benefit. While the various embodiments are particularly useful for client computing devices, which are resource-constrained systems, the embodiments are generally useful in any computing device that includes a processor and executes software applications.

In overview, various embodiments include systems and methods, and computing devices (e.g., server computing devices, client computing devices, etc.) configured to implement the methods, for protecting a corporate network and client computing devices from malware and other non-benign applications or behaviors. Since such non-benign applications or behaviors may cause degradation in the performance and functioning of the computing device or corporate network, the various embodiments may improve the performance and functioning of the computing device and corporate network by protecting against such applications/behaviors.

Various embodiments may include a server computing device that is configured with a software or processor executable code for evaluating software applications (e.g., mobile apps, etc.) designed for execution in client devices. The server computing device may systematically execute, explore, exercise, run, drive, or crawl a software application in a sandboxed, emulated or controlled environment. Consistent with terms used in the art, software performing operations of the server computing device in accordance with the various embodiments is referred to herein as a “detonator component.”

Various embodiments may further include a multitude of client computing devices (e.g., mobile or resource-constrained computing devices, etc.) that are configured to work in conjunction with the detonator component (server computing device). Each of the client computing devices may be configured to individually accomplish client-driven detonation. Client-driven detonation may include a client computing device establishing a secure communication link to the detonator component, and using the secure communication link to control, guide, inform, and/or issue requests to the detonator component. For example, a client computing device may use the secure communication link to request that the detonator component evaluate specific aspects or behaviors of a specific software application and/or to determine whether a software application is non-benign.

In addition to the client-driven detonation operations discussed above, each of client computing devices may be configured to collect and send various different types of data to the detonator component. Such data may include information identifying the hardware and software configurations of the devices, a software application that is to be evaluated, a list of activities in the software application that are explored, a list of GUI screens that are explored, a list of activities of the application that remain unexplored, a list of GUI screens that remain unexplored, a confidence level for the software application, a list of unexplored behaviors, hardware configuration information, software configuration information, collected behavior information, generated behavior vectors, classifier models, the results of its analysis operations, locations of buttons, text boxes or other electronic user input components that are displayed on the electronic display of the client device, and other similar information.

Informed by the data received from the multitude of client devices, the detonator component may perform collaborative detonation operations. The collaborative detonation operations may include emulating the runtime environment of client computing devices, and exercising or stress testing the software applications through a variety of configurations, operations, activities, screens and user interactions. The detonator component may collect information on the behaviors of each software application during the exercising/stress tests, and use the collected information to perform various analysis operations (e.g., static analysis operations, dynamic analysis operations, behavior-based analysis operations, etc.). The detonator component may generate analysis results, and use the generated analysis results (along with the received data) to evaluate the software application for a variety of different behaviors, threats, conditions, or risks. The detonator component may also use the analysis results and received data to update its emulator or to focus its operations on evaluating specific (or the most important) device behaviors, software activities, screens, user interface elements, electronic keys, layouts, etc.

The detonator component may also work in conjunction with the multitude of client computing devices to “capture joint coverage,” perform distribution-driven detonation operations, identify and evaluate time-specific and/or locale-specific behaviors of software applications, jointly rank software applications for evaluation, and optimize data collection.

The detonator component may “capture joint coverage” by collecting and combining input and data from independent executions of different instances of the same software application on different client devices. The detonator component may use the combined data to generate a joint coverage table (or map, graph, hash, etc.), and use the generated joint coverage table to identify the activities (or code paths, activity paths, etc.) that should be explored or evaluated in order to efficiently determine whether the software application is benign or non-benign. The detonator component may then focus its operations on evaluating the identified activities.

For example, the detonator component may be configured to obtain and combine lists of activities that have been explored by users of a specific software application, hardware and software configuration information of the devices equipped with the software application, and behavior vectors generated by the security systems (e.g., behavior-based dynamic analysis systems, etc.) that are installed on the client devices. The detonator component may use any or all such information to determine (or estimate, predict, etc.) potential activities of the software application, how frequently each activity is performed, the activities that remain unexplored, the operating systems or execution environments that have not yet been evaluated, etc. The detonator component may stress test or exercise the software application through previously unexplored activities (or the less-frequent activities) to determine whether the software application has the potential to engage in a suspicious or non-benign behavior (e.g., send an SMS message after reading the device ID, etc.). The detonator component may also focus its operations on evaluating activities or screens that frequently generate suspicious behavior vectors (i.e., activities that are associated with behaviors that are frequently classified as suspicious by the client device's security system). In some embodiments, the detonator component may further focus its operations on evaluating the activities or screens that are reachable (or which are dependent on, generated as a result of, etc.) from the activities or screens that frequently generate suspicious behavior vectors.

In some embodiments, the detonator component may be configured to perform distribution-driven detonation operations. These operations may include using the inputs and data received from different client devices to identify activities/screens of a software application, and computing conditional probability distribution values for each of the identified activities/screens. The detonator component may compute the conditional probability distribution values for different numbers of suspicious behavior vectors that are associated with the application when the activity is visited, detected or present on the device. The detonator component may also compute and compare conditional probability distribution values for different numbers of suspicious behavior vectors that are associated with the application when the activity is not visited, detected, or present on the device. The detonator component may compute the distances between conditional probability distribution values (e.g., the values when an activity is visited vs. the values when the activity is not visited, etc.). The detonator component may prioritize the values (or their associated activities/screens) based on the computed distances. For example, the detonator component may determine that the larger distances indicate that there is a higher probability that an activity is suspicious, and focus its operations on evaluating the activities associated with larger distances first.

In some embodiments, the detonator component may be configured to identify and evaluate time-specific and/or locale-specific behaviors of software applications. That is, certain applications engage in non-benign behaviors only under specific conditions, during specific times (e.g., at night, 3:00 AM on Sundays, etc.), or when the client device is located in specific areas (e.g., within five miles of a user's home address, inside the city of Washington D.C., within the state of Colorado, inside the country of Azerbaijan, etc.). The detonator component may be configured to identify and evaluate these time-specific or locale-specific activities/screens to determine whether the software application is non-benign.

In some embodiments, the detonator component may be configured to jointly rank software applications. When multiple software applications are available for evaluation, the detonator component may compute a joint ranking value for each software application, and use the joint ranking value to determine the software application that is to be evaluated first (e.g., the software application that has the highest probability of engaging in non-benign behaviors, etc.). The detonator component may use a combination of different metrics (for code coverage, malware detection, etc.) to compute the joint ranking values and/or to select the software application for evaluation. The detonator component may determine the joint ranking values as a function of overall activity coverage, number of suspicious behavior vectors associated with the application or activity, estimated number of CPU cycles associated with the application/activity, etc. In an embodiment, in order to avoid potential starvation, the detonator component may use a randomization function (or otherwise incorporate some degree of randomization) to determine whether to select a software application for evaluation. For example, the detonator component may select applications for evaluation based on their joint ranking value only fifty percent of the time, and select applications at random the other fifty percent of the time.

In some embodiments, the detonator component may be configured to perform various operations to improve or optimize data collection. For example, the detonator component may be equipped with a “turn-off switch” that provides feedback to the client computing devices to indicate that it has received sufficient inputs/data, or that no additional data is needed from specific group of users or client computing devices. This improves the performance and efficiency of the detonator component by simplifying or reducing the number of data management operations performed, and reducing the amount of data that is exchanged or communicated over the network. Such feedback may also reduce the network usage costs incurred by the client computing devices.

In some embodiments, the server computing device (or detonator component) may be configured to intelligently identify malware and/or other non-benign applications before the applications are downloaded onto a corporate network and/or before the applications are downloaded, installed, or executed on a client computing device.

In some embodiments, the server computing device (or detonator component) may be configured to exercise, evaluate or stress test “Apps” or software applications that are designed for execution and use in mobile or other resource-constrained computing devices.

In some embodiments, the server computing device (or detonator component) may be configured to evaluate a large variety of conditions, factors and features of the software application and/or client computing device to determine whether a behavior or software application is non-benign.

In some embodiments, the server computing device (or detonator component) may be configured to evaluate apps quickly, efficiently, and adaptively without having a significant negative and/or user-perceivable impact on the responsiveness, performance, or power consumption characteristics of the client computing device.

In some embodiments, the server computing device (or detonator component) may be configured to identify the presence, existence or locations of buttons, text boxes, or other electronic user input components that are displayed on the electronic display screens of client computing devices, and evaluate any or all of these identified conditions, features, or factors to determine whether a behavior or software application is non-benign.

In some embodiments, the server computing device (or detonator component) may be configured to determine the number of activities or screens used by a software application, determine the relative importance of individual activities or screens, and use this information to determine whether a behavior or software application is non-benign.

In some embodiments, the server computing device (or detonator component) may be configured to use real or live data that is collected from the use of the software application on a client computing device to more fully exercise or stress test software applications that are designed for execution on a client computing device.

The various embodiments improve the functioning of a computing device by improving its security, performance, and power consumption characteristics. For example, by offloading processor or battery intensive operations for determining whether a software application is suspicious to a server computing device, the various embodiments allow the computing device to quickly and intelligently determine whether a software application is non-benign. This improves the device's performance and power consumption characteristics. Additional improvements to the functions, functionalities, and/or functioning of computing devices will be evident from the detailed descriptions of the embodiments provided below.

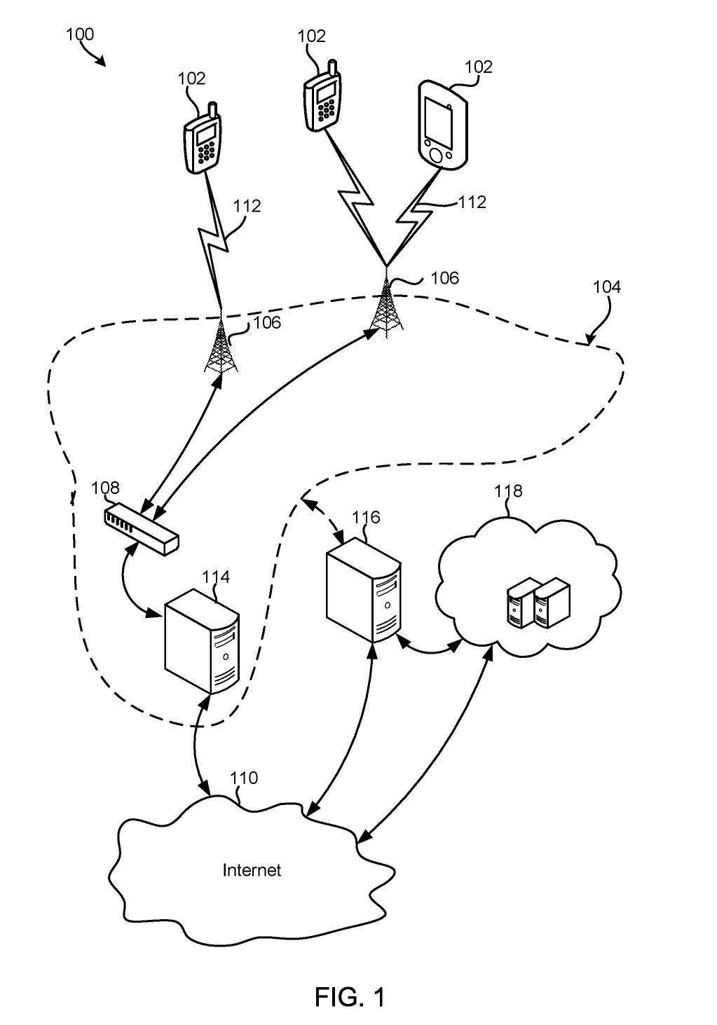

Various embodiments may be implemented within a variety of communication systems, such as the example communication system 100 illustrated in FIG. 1. A typical cell telephone network 104 includes a plurality of cell base stations 106 coupled to a network operations center 108, which operates to connect calls (e.g., voice calls or video calls) and data between client computing devices 102 (e.g., cell phones, laptops, tablets, etc.) and other network destinations, such as via telephone land lines (e.g., a plain old telephone service (POTS) network, not shown) and the Internet 110. Communications between the client computing devices 102 and the telephone network 104 may be accomplished via two-way wireless communication links 112, such as fourth generation (4G), third generation (3G), code division multiple access (CDMA), time division multiple access (TDMA), long term evolution (LTE) and/or other mobile communication technologies. The telephone network 104 may also include one or more servers 114 coupled to or within the network operations center 108 that provide a connection to the Internet 110.

The communication system 100 may further include network servers 116 connected to the telephone network 104 and to the Internet 110. The connection between the network servers 116 and the telephone network 104 may be through the Internet 110 or through a private network (as illustrated by the dashed arrows). A network server 116 may also be implemented as a server within the network infrastructure of a cloud service provider network 118. Communication between the network server 116 and the client computing devices 102 may be achieved through the telephone network 104, the internet 110, private network (not illustrated), or any combination thereof. In an embodiment, the network server 116 may be configured to establish a secure communication link to the client computing device 102, and securely communicate information (e.g., behavior information, classifier models, behavior vectors, etc.) via the secure communication link.

The client computing devices 102 may request the download of software applications from a private network, application download service, or cloud service provider network 118. The network server 116 may be equipped with an emulator, exerciser, and/or detonator components that are configured to receive or intercept a software application that is requested by a client computing device 102. The emulator, exerciser, and/or detonator components may also be configured to emulate the client computing device 102, exercise or stress test the received/intercepted software application, and perform various analysis operations to determine whether the software application is benign or non-benign.

For example, in some embodiments, the network server 116 may be equipped with a detonator component that is configured to receive data collected from independent executions of different instances of the same software application on different client computing devices. The detonator component may combine the received data, and use the combined data to identify unexplored code space or potential code paths for evaluation. The detonator component may exercise the software application through the identified unexplored code space or identified potential code paths via an emulator (e.g., a client computing device emulator), and generate analysis results that include, represent, or analyze the information generated during the exercise. The network server 116 may determine whether the software application is non-benign based on the generated analysis results.

Thus, the network server 116 may be configured to intercept software applications before they are downloaded to the client computing device 102, emulate a client computing device 102, exercise or stress test the intercepted software applications, and determine whether any of the intercepted software applications are benign or non-benign. In some embodiments, the network server 116 may be equipped with a behavior-based security system that is configured to determine whether the software application is benign or non-benign. In an embodiment, the behavior-based security system may be configured to generate machine learning classifier models (e.g., an information structure that includes component lists, decision nodes, etc.), generate behavior vectors (e.g., an information structure that characterizes a device behavior and/or represents collected behavior information via a plurality of numbers or symbols), apply the generated behavior vectors to the generated machine learning classifier models to generate an analysis result, and use the generated analysis result to classify the software application as benign or non-benign.

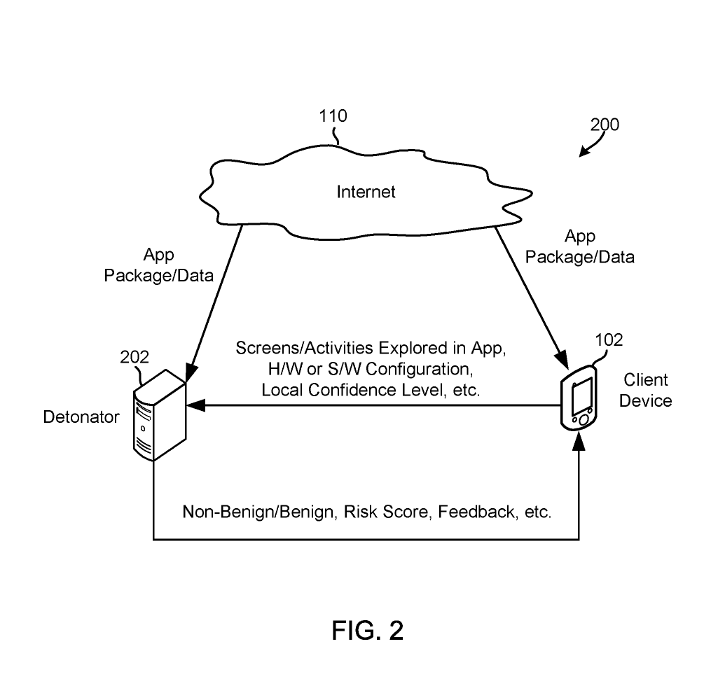

FIG. 2 illustrates an example system 200 that includes a detonator component 202 that may be configured to evaluate software application in accordance with the various embodiments. A secure communication link may be established between the detonator component 202 and a client computing device 102. For example, the detonator component 202 may establish the secure communication link to the client computing device in response to receiving a request to download an application from the client computing device 102, in response to determining that it has received a software application requested by the client computing device 102, etc. As a further example, the client computing device 102 may establish the secure communication link to the detonator component 202 in response to determining that a software application is to be downloaded from an application download service. The client computing device 102 may also establish the secure communication link in response to receiving the software application. The client computing device 102 may also establish the secure communication link in response to determining that the received software application is suspicious or non-benign. The client computing device 102 may also establish the secure communication link in response to collecting user input data during the execution of the software application on the client computing device 102.

The detonator component 202 may be configured to receive exercise information (e.g., confidence level, a list of explored activities, a list of explored GUI screens, a list of unexplored activities, a list of unexplored GUI screens, a list of unexplored behaviors, hardware configuration information, software configuration information, behavior vectors, etc.) from the client computing device 102 via the secure communication link. The detonator component 202 may send information (e.g., risk score, security rating, behavior vectors, classifier models, etc.) to the client computing device 102 via the same or different secure communication link.

The detonator component 202 may be configured to receive a software application (or application package, application data, etc.) from an application download service or via the internet 110. The detonator component 202 may be configured to exercise or stress test the received software application in a client computing device emulator. The detonator component 202 may be configured to identify one or more activities or behaviors of the software application and/or client computing device 102, and rank the activities or behaviors in accordance with their level of importance. The detonator component 202 may be configured to prioritize the activities or behaviors based on their rank, and analyze the activities or behaviors in accordance with their priorities. The detonator component 202 may be configured to generate analysis results, and use the analysis results to determine whether the identified behaviors are benign or non-benign. The detonator component 202 may send the received software application to, or otherwise allow the software application to be received in, the client computing device 102 in response to determining that the identified behaviors are benign.

In response to determining that the software application or any of identified behaviors are non-benign, the detonator component 202 may quarantine the software application and send security warnings or notification messages to the client computing device 102. In response, the client computing device 102 may take corrective actions or implement preventive measures.

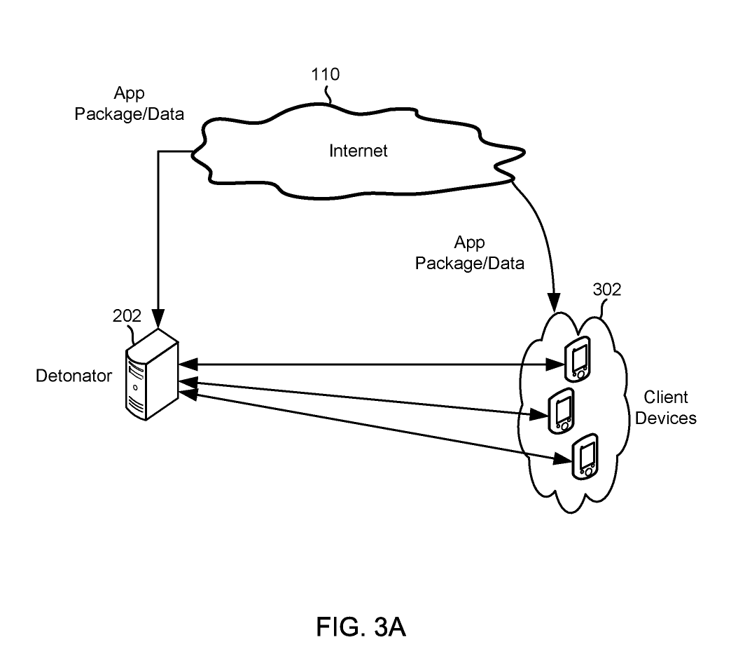

FIG. 3A illustrates how the detonator component 202 may be configured to work in conjunction with a plurality (or many, a multitude, etc.) of client computing devices 302. Each of the client computing devices in the multitude of client computing devices 302 may be configured to establish a secure communication link to the detonator component. The client computing devices may use the secure communication link to control, guide, inform, and/or issue requests to the detonator component 202. In addition, each of the client computing devices may be configured to collect and send various different types of data to the detonator component, including hardware configuration information, software configuration information, information identifying a software application that is to be evaluated in the detonator component 202, a list of activities or screens associated with the software application, a list of activities of the application that have been explored, a list of activities of the application that remain unexplored, a confidence level for the software application, a list of unexplored behaviors, collected behavior information, generated behavior vectors, classifier models, the results of its analysis operations, locations of buttons, text boxes or other electronic user input components that are displayed on the electronic display of the client device, and other similar information.

The detonator component 202 may be configured to receive and use this data to perform collaborative detonation operations, capture joint coverage (e.g., by generating and using a joint coverage information structure, etc.), perform distribution-driven detonation operations, identify and evaluate time-specific and/or locale-specific behaviors of software applications, jointly rank software applications for evaluation, and/or optimize data collection.

FIG. 3B illustrates example logical component and information flows in a detonator component 202 that is configured to work in conjunction with a multitude/plurality of client computing devices 302 in accordance with the various embodiments. In the example illustrated in FIG. 3B, the detonator component 202 includes a data collection and combination component 310, a compiler component 312, a ranking component 314 and a cycle component 316.

The data collection and combination component 310 may be configured to collect and combine inputs and data received from the multitude/plurality of client computing devices 302. The inputs may be provided by the on-device security mechanism to the detonator component 202. These inputs may be exchanged over a secure communication channel. These inputs may include information that captures/identifies the collective experience of many different users of the same application. Using such inputs from multiple users (or the collective experience) may allow the detonator component 202 to evaluate the applications more comprehensively (e.g., because it can construct a more detailed and composite picture of application behavior, etc.).

The compiler component 312 may be configured to compile, determine, compute and/or update unexplored space, such as versions of the operating system that have not yet been evaluated or used, unexplored activities of a software application that have not yet been evaluated, relevant time and locations in which the software application has not been tested, the combination of hardware configuration and software configuration in which the application has not been evaluated by different users, etc.

The ranking component 314 may be used to select a “promising” application for malware detection when multiple applications are available at the detonator. The ranking component 314 may be configured to use different metrics (for code coverage, malware detection, etc.) to rank applications and/or select an application for evaluation. Each of these metrics may be multiplied by a weight, parameter or scaling factor, and combined together (e.g., through summation operation) in order to compute the rank. These set of weights, parameters or scaling factors may represent or be generated by a machine learning model, and the set of weights, parameters or scaling factors may be “learned” using an appropriate training dataset generated for this purpose.

The cycle component 316 may be configured to cycle the selected application through unexplored spaces and perform collaborative detonation operations. The resulting experience of executing the application at the detonator (e.g., the analysis or detonation results generated by the detonator component, etc.) may be fed back to the data collection and combination component 310. In addition, these results generated by the cycle component 316 may include various elements, parameters, data fields and values, including a code coverage score and risk score, may be fed back to different mobile devices, etc. In a high level implementation, the detonator's feedback may include the identification of suspicious or malicious or non-benign applications, etc. In a more detailed level implementation, the detonator may pinpoint specific activities or screens within applications that are suspicious, malicious or non-benign, in which case the detonator feedback to the device may include a list of suspicious or malicious or non-benign screens in the application. The operating system on the device may use any or all such information to prevent users from visiting activities or screens (e.g., activities or screens determined to be non-benign).

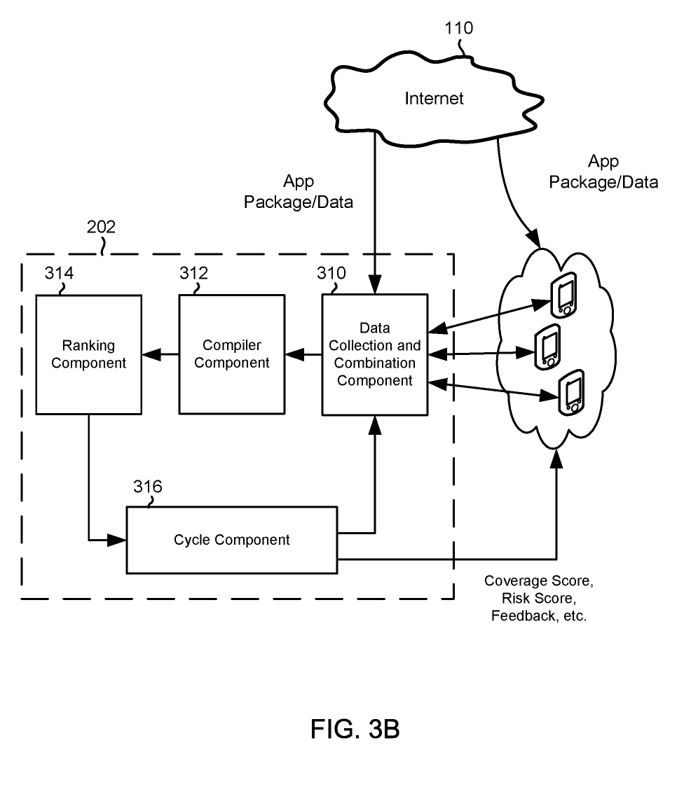

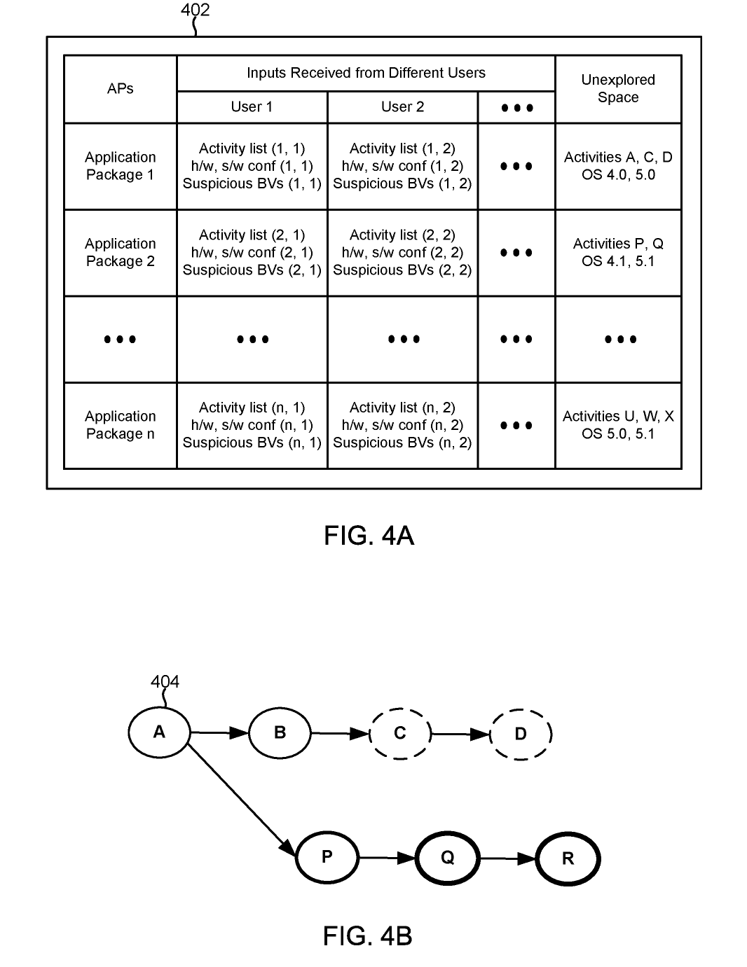

FIG. 4A illustrates an example joint coverage table information structure 402 that may be generated and used by the detonator component 202 in accordance with some embodiments. In the example illustrated in FIG. 4A, the joint coverage table 402 includes data for each user (e.g., User 1, User 2) of each of a plurality of applications (e.g., Application Package 1, Application Package 2, etc.). The data may include an activity list, hardware and software configuration information, and suspicious behavior vectors. The joint coverage table 402 also identifies unexplored activities (or Unexplored Space) for each application. For example, the joint coverage table 402 indicates that activities A, C, and D of Application Package 1 remain unexplored in versions 4.0 and 5.0 of a specific operating system or execution environment (e.g., Android, OS10, etc.).

FIG. 4B illustrates an example activity graph information structure that may be generated (e.g., based on the application package and the joint coverage table information structure 402) and used by the detonator component 202 in accordance with the various embodiments. In the example illustrated in FIG. 4B, the activity graph information structure includes a root node 404 that identifies a first activity (activity A). The activity graph information structure also indicates that activity A may lead to activities B and P (or that activity B and activity P are reachable from activity A), that activity B may lead to activity C and then activity D, and that activity P may lead to activity Q and then activity R.

The detonator component 202 may use the activity graph information structure to determine or identify potential paths that could lead to non-benign behavior, and thus should be explored. For example, the detonator component could determine that activities C and D have not yet been explored, and thus the path A→B→C→D should be evaluated. The detonator component may also determine that activities Q and R are associated with a large number of suspicious behavior vectors, and thus path A→P→Q→R should be further evaluated and/or marked as suspicious or non-benign.

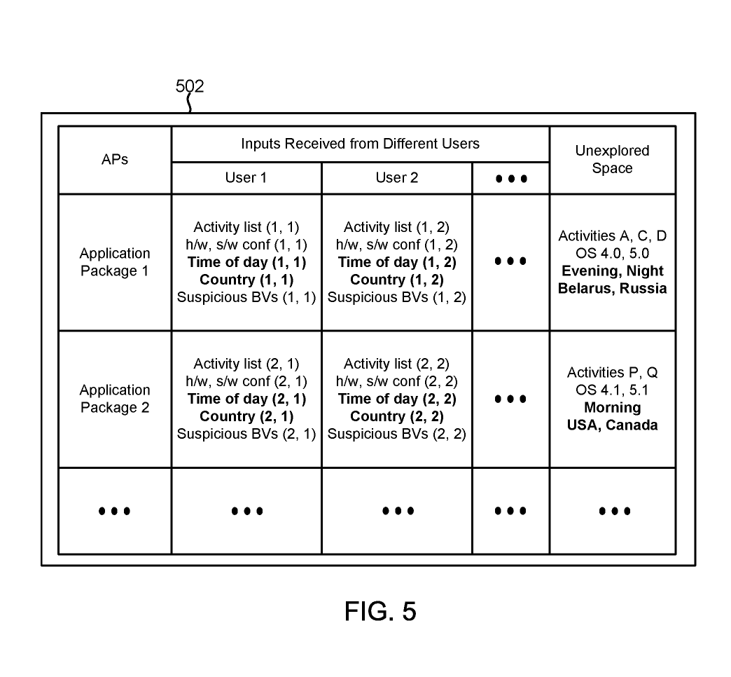

FIG. 5 illustrates another example joint coverage table information structure 502 that may be generated and used by the detonator component 202 in accordance with some embodiments. In the example illustrated in FIG. 5, the joint coverage table 502 includes data that identifies a time of day and country (or location) of the user of an application. The detonator component could use this additional data to identify and evaluate time-specific and/or locale-specific behaviors of software applications.

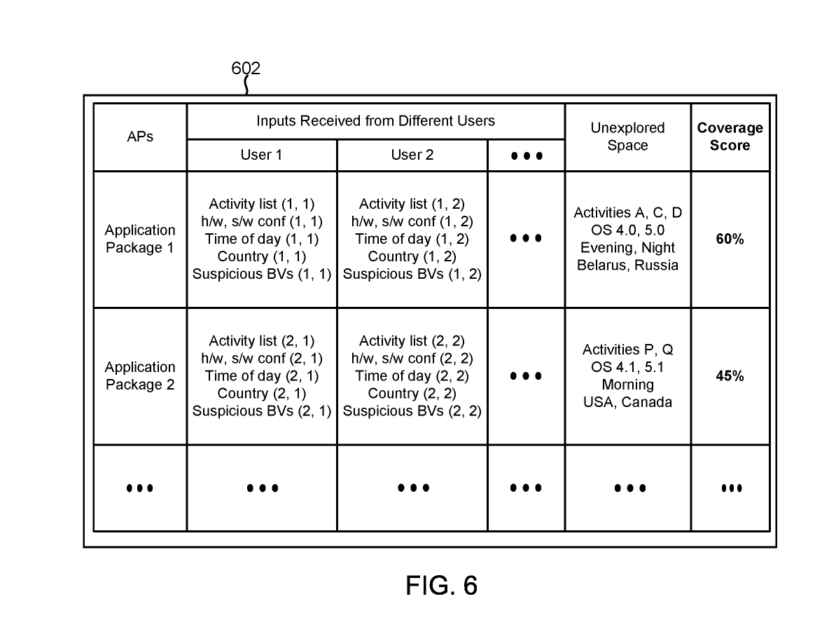

FIG. 6 illustrates another example joint coverage table information structure 602 that may be generated and used by the detonator component 202 in accordance with some embodiments. In the example illustrated in FIG. 6, the joint coverage table 602 includes a coverage score column that identifies a joint ranking for each of the applications. The detonator component may use the joint coverage table 602 to jointly rank the software applications for evaluation. For example, the detonator component 202 may use a combination of different metrics to compute a joint ranking value of 60% for Application Package 1, and a joint ranking value of 45% for Application Package 2. The detonator component 202 may then use these joint ranking value to determine the software application that is to be evaluated first (Application Package 1) and/or to determine the level of detail or security that should be used when evaluating the application.

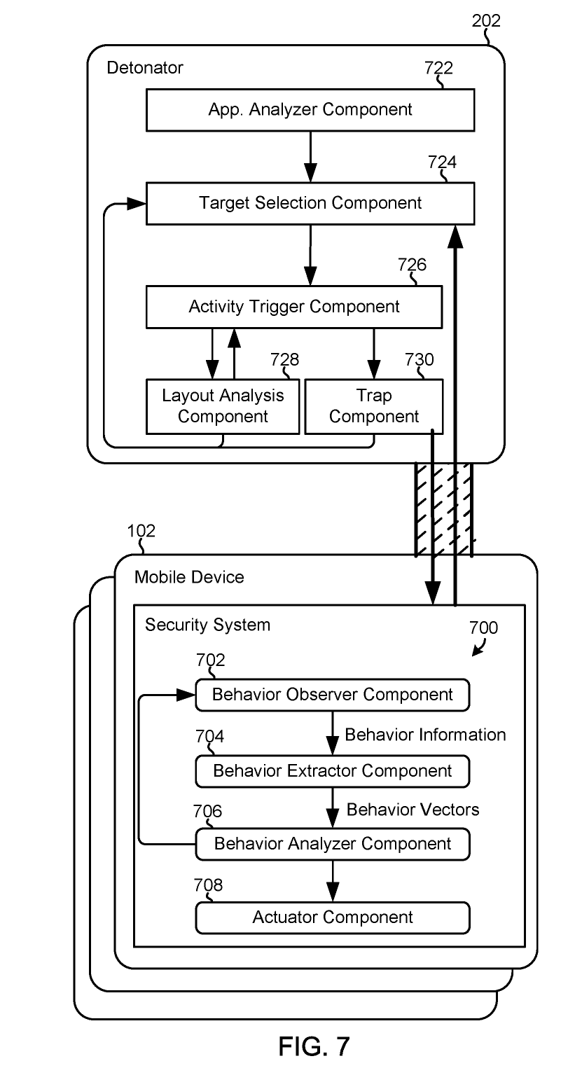

FIG. 7 illustrates various components and information flows in a system that includes a detonator component 202 executing in a server and a client computing device 102 configured in accordance with the various embodiments. In the example illustrated in FIG. 7, the detonator component 202 includes an application analyzer component 722, a target selection component 724, an activity trigger component 726, a layout analysis component 728, and a trap component 730. The client computing device 102 includes a security system 700 that includes a behavior observer component 702, a behavior extractor component 704, a behavior analyzer component 706, and an actuator component 708.

As mentioned above, the detonator component 202 may be configured to exercise a software application (e.g., in a client computing device emulator) to identify one or more behaviors of the software application and/or client computing device 102, and determine whether the identified behaviors are benign or non-benign. As part of these operations, the detonator component 202 may perform static and/or dynamic analysis operations.

Static analysis operations that may be performed by the detonator component 202 may include analyzing byte code (e.g., code of a software application uploaded to an application download service) to identify code paths, evaluating the intent of the software application (e.g., to determine whether it is malicious, etc.), and performing other similar operations to identify all or many of the possible operations or behavior of the software application.

The dynamic analysis operations that may be performed by the detonator component 202 may include executing the byte code via an emulator (e.g., in the cloud, etc.) to determine all or many of its behaviors and/or to identify non-benign behaviors.

In an embodiment, the detonator component 202 may be configured to use a combination of the information generated from the static and dynamic analysis operations (e.g., a combination of the static and dynamic analysis results) to determine whether the software application or behavior is benign or non-benign. For example, the detonator component 202 may be configured to use static analysis to populate a behavior information structure with expected behaviors based on application programming interface (API) usage and/or code paths, and to use dynamic analysis to populate the behavior information structure based on emulated behaviors and their associated statistics, such as the frequency that the features were excited or used. The detonator component 202 may then apply the behavior information structure to a machine learning classifier to generate an analysis result, and use the analysis result to determine whether the application is benign or non-benign.

The application analyzer component 722 may be configured to perform static and/or dynamic analysis operations to identify one or more behaviors and determine whether the identified behaviors are benign or non-benign. For example, for each activity (i.e., GUI screen), the application analyzer component 722 may perform any of a variety of operations, such as count the number of lines of code, count the number of sensitive/interesting API calls, examine its corresponding source code, call methods to unroll source code or operations/activities, examine the resulting source code, recursively count the number of lines of code, recursively count the number of sensitive/interesting API calls, output the total number of lines of code reachable from an activity, output the total number of sensitive/interesting API calls reachable from an activity, etc. The application analyzer component 722 may also be used to generate the activity transition graph for the given application that captures how the different activities (i.e., GUI screens) are linked to one another.

The target selection component 724 may be configured to identify and select high value target activities (e.g., according to the use case, based on heuristics, based on the outcome of the analysis performed by the application analyzer component 722, as well as the exercise information received from the client computing device, etc.). The target selection component 724 may also rank activities or activity classes according to the cumulative number of lines of code, number of sensitive or interesting API calls made in the source code, etc. Examples of sensitive APIs for malware detection may include takePicture, getDeviceId, etc. Examples of APIs of interest for energy bug detection may include Wakelock.acquire, Wakelock.release, etc. The target selection component 724 may also prioritize visiting of activities according to the ranks, and select the targets based on the ranks and/or priorities.

Once the current target activity is reached and explored, a new target may be selected by the target selection component 724. In an embodiment, this may be accomplished by comparing the number of sensitive/interesting API calls that are actually made during runtime with the number of sensitive/interesting API calls that are determined by the application analyzer component 722. Further, based on the observed runtime behavior exhibited by the application, some of the activities (including those that have been explored already) may be re-ranked and explored/exercised again on the emulator.

Based on the activity transition graph determined in the application analyzer component 722, the activity trigger component 726 may determine how to trigger a sequence of activities that will lead to the selected target activities, identify entry point activities from the manifest file of the application, for example, and/or emulate, trigger, or execute the determined sequence of activities using the Monkey tool.

The layout analysis component 728 may be configured to analyze the source code and/or evaluate the layout of display or output screens to identify the different GUI controls (button, text boxes, etc.) visible on the GUI screen, their location, and other properties such as whether a button is clickable.

The trap component 730 may be configured to trap or cause a target behavior. In some embodiments, this may include monitoring activities of the software application to collect behavior information, using the collected behavior information to generate behavior vectors, applying the behavior vectors to classifier models to generate analysis results, and using the analysis results to determine whether a software application or device behavior is benign or non-benign.

Each behavior vector may be a behavior information structure that encapsulates one or more “behavior features.” Each behavior feature may be an abstract number that represents all or a portion of an observed behavior. In addition, each behavior feature may be associated with a data type that identifies a range of possible values, operations that may be performed on those values, meanings of the values, etc. The data type may include information that may be used to determine how the feature (or feature value) should be measured, analyzed, weighted, or used. As an example, the trap component 730 may generate a behavior vector that includes a “location_background” data field whose value identifies the number or rate that the software application accessed location information when it was operating in a background state. This allows the trap component 730 to analyze this execution state information independent of and/or in parallel with the other observed/monitored activities of the software application. Generating the behavior vector in this manner also allows the system to aggregate information (e.g., frequency or rate) over time.

A classifier model may be a behavior model that includes data and/or information structures (e.g., feature vectors, behavior vectors, component lists, decision trees, decision nodes, etc.) that may be used by the computing device processor to evaluate a specific feature or embodiment of the device's behavior. A classifier model may also include decision criteria for monitoring and/or analyzing a number of features, factors, data points, entries, APIs, states, conditions, behaviors, software applications, processes, operations, components, etc. (herein collectively referred to as “features”) in the computing device.

In the client computing device 102, the behavior observer component 702 may be configured to instrument or coordinate various application programming interfaces (APIs), registers, counters or other components (herein collectively “instrumented components”) at various levels of the client computing device 102. The behavior observer component 702 may repeatedly or continuously (or near continuously) monitor activities of the client computing device 102 by collecting behavior information from the instrumented components. In an embodiment, this may be accomplished by reading information from API log files stored in a memory of the client computing device 102.

The behavior observer component 702 may communicate (e.g., via a memory write operation, function call, etc.) the collected behavior information to the behavior extractor component 704, which may use the collected behavior information to generate behavior information structures that each represent or characterize many or all of the observed behaviors that are associated with a specific software application, module, component, task, or process of the client computing device. Each behavior information structure may be a behavior vector that encapsulates one or more “behavior features.” Each behavior feature may be an abstract number that represents all or a portion of an observed behavior. In addition, each behavior feature may be associated with a data type that identifies a range of possible values, operations that may be performed on those values, meanings of the values, etc. The data type may include information that may be used to determine how the feature (or feature value) should be measured, analyzed, weighted, or used.

The behavior extractor component 704 may communicate (e.g., via a memory write operation, function call, etc.) the generated behavior information structures to the behavior analyzer component 706. The behavior analyzer component 706 may apply the behavior information structures to classifier models to generate analysis results, and use the analysis results to determine whether a software application or device behavior is benign or non-benign (e.g., malicious, poorly written, performance-degrading, etc.).

The behavior analyzer component 706 may be configured to notify the actuator component 708 that an activity or behavior is not benign. In response, the actuator component 708 may perform various actions or operations to heal, cure, isolate, or otherwise fix identified problems. For example, the actuator component 708 may be configured to terminate a software application or process when the result of applying the behavior information structure to the classifier model (e.g., by the analyzer module) indicates that a software application or process is not benign.

The behavior analyzer component 706 also may be configured to notify the behavior observer component 702 in response to determining that a device behavior is suspicious (i.e., in response to determining that the results of the analysis operations are not sufficient to classify the behavior as either benign or non-benign). In response, the behavior observer component 702 may adjust the granularity of its observations (i.e., the level of detail at which client computing device features are monitored) and/or change the factors/behaviors that are observed based on information received from the behavior analyzer component 706 (e.g., results of the real-time analysis operations), generate or collect new or additional behavior information, and send the new/additional information to the behavior analyzer component 706 for further analysis. Such feedback communications between the behavior observer and behavior analyzer components 702, 706 enable the client computing device processor to recursively increase the granularity of the observations (i.e., make finer or more detailed observations) or change the features/behaviors that are observed until behavior is classified as either benign or non-benign, until a processing or battery consumption threshold is reached, or until the client computing device processor determines that the source of the suspicious or performance-degrading behavior cannot be identified from further increases in observation granularity. Such feedback communications also enable the client computing device 102 to adjust or modify the classifier models locally in the client computing device 102 without consuming an excessive amount of the client computing device's 102 processing, memory, or energy resources.

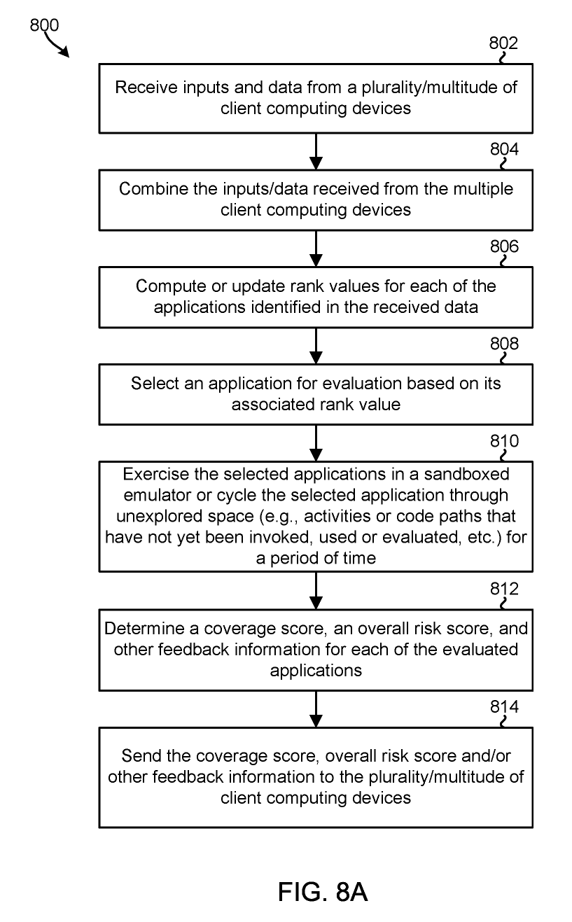

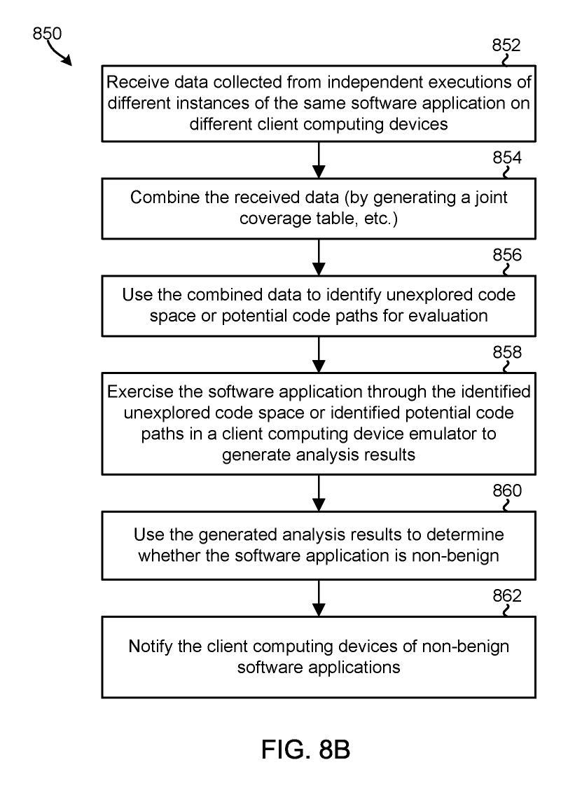

FIG. 8A illustrates a server method 800 for protecting a client computing device in accordance with various embodiments. Method 800 may be performed by a server processor in a server computing device that implements all or portions of a detonator component. In block 802, the server processor may receive inputs and data (e.g., inputs that identify user-interactions with software application, behavior vectors, etc.) from a plurality of client computing devices. Such inputs may be received over a secure communication channel that is established between a client computing device and the server computing device. The client computing device may send these inputs to the detonator periodically or at select time(s) (e.g., when user-driven detonation is initiated or detected).

In block 804, the server processor may combine the inputs and data received from multiple client computing devices (e.g., to generate a joint coverage table, etc.). In an embodiment, the received inputs and data may be exercise information that includes information identifying a confidence level for the software application, a list of explored activities, list of explored GUI screens, a list of unexplored activities, list of unexplored GUI screens, a list of unexplored behaviors, hardware configuration information, software configuration information, etc. In addition, the received inputs and data may include data generated from exploration or execution of the application at the detonator, as well as inputs, data, and analysis/detonation results from other detonator servers in the system.

In block 806, the server processor may determine, calculate, compute or update rank values for each of the applications identified in the received data, i.e., when multiple applications are present. The ranking of the applications may depend on different metrics, such as code coverage achieved, number of suspicious or non-benign behaviors exhibited by the applications, etc. As such, in some embodiments, the server processor may determine the rank values based on code coverage, number of suspicious or non-benign behavior vectors, and other similar information.

In block 808, the server processor may select an application for evaluation based on rank. In some embodiments, the server processor may incorporate some degree of randomization (e.g., via a randomization procedure or function call, etc.) to select the next application for evaluation. In some embodiments, the server processor may randomize the selection of applications (e.g., instead of using the ranking procedure) so as to overcome or reduce the potential for starvation that might otherwise occur if the applications were not selected at random.

In block 810, the server processor may cycle the selected applications through the space determined for exploration (e.g., unexplored space, etc.) for a period of time (e.g., based on a maximum cycle period value, etc.) to exercise the software application in a sandboxed emulator, and generate analysis results. In exercising the received software application in the mobile device emulator, the server processor may intelligently execute the software application in an attempt to elicit behaviors that may be non-benign. In other words, leveraging exercise information received from the client devices, as well as an analysis of the software application itself, the server processor may select for execution particular activities, GUI interfaces to trigger, and operating modes that analysis indicates have increased probabilities of involving or triggering non-benign behavior.

In block 812, the server processor may use the generated analysis results to determine or compute a coverage score and an overall risk score for each of the evaluated applications. Also in block 812, the server processor may generate cause-analysis feedback information for each application. In some embodiments, the server processor may generate feedback information with different levels of detail.

In block 814, the server processor may send the coverage scores, overall risk scores, and/or cause-analysis feedback information to the client computing devices. In implementation providing high level feedback (e.g., a first granularity level), the detonator's feedback may include identification of suspicious or malicious or non-benign applications, etc. In implementation providing more detailed feedback (e.g., a second, third or fourth granularity level, etc.), the detonator may pinpoint specific activities or screens within applications that are suspicious or malicious or non-benign. For example, the feedback to the device may include a list of suspicious or malicious or non-benign screens in the application. An operating system (e.g., on the client computing device) may use this information to identify non-benign screens and/or to prevent users from visiting non-benign screens.

FIG. 8B illustrates another server method 850 for protecting a client computing device in accordance with various embodiments. Method 850 may be performed by a server processor in a server computing device that implements all or portions of a detonator component. In block 852, the server processor may receive data collected from independent executions of different instances of the same software application on different client computing devices. The different instances of a given application may correspond to runs with different sets of activities or screens explored, and/or different times and locations, and/or different hardware configuration and software configuration, etc.

In block 854, the server processor may combine the received data (by generating a joint coverage table, etc.). For each application and for each user, the joint coverage table may include a list of activities or screen visited/explored, the time and locale information, hardware and software configurations, etc. Capturing this information in a tabular structure (e.g., the information structures illustrated in FIGS. 4A, 5, and 6) allows the server processor to identify the unexplored code space or potential code paths for further evaluation.

In block 856, the server processor may use the combined data to identify unexplored code space or potential code paths for evaluation. The identified space may represent activities, behaviors or screens that remain unexplored by any of the users in the available data; activities, behaviors or screens that are less-explored (i.e., explored less frequently); and/or activities, behaviors or screens that otherwise warrant further exploration.

In some embodiments, the server processor may identify unexplored code space or potential code paths for evaluation in block 856 by using the received data to determine, for each of a plurality of activities associated with a software application, first conditional probability distribution values for different numbers of suspicious behaviors with respect to the condition in which an activity is visited, and second conditional probability distribution values for different numbers of suspicious behaviors with respect to the condition in which an activity is not visited. Based upon the determined first and second conditional probability distribution values for each of a plurality of activities associated with a software application, the server processor may compute a distance value, and then select an activity for evaluation based on the computed distance value.

In block 858, the server processor may exercise the software application through the identified unexplored code space or identified potential code paths in a client computing device emulator to generate analysis results. Such exercising of the applications may enable the server processor to trigger previously unexplored code paths in the applications, and help in determining/identifying the activities/screens that generate suspicious or malicious or non-benign behaviors.

In block 860, the server processor may use the generated analysis results to determine whether the software application is non-benign. A software application identified as non-benign may correspond to those malware applications that cause malicious economic activity, those that leak private data, those with undesirable network usage, those with undesirable energy usage, those with bugs, etc.

In block 862, the server processor may notify the client computing devices of non-benign software applications. Such notification may occur over a secure communication channel established between the server processor and the client computing devices. Based on the type of feedback provided, the on-device security system, the underlying operating system, and/or the end-user may perform the appropriate actuation steps to limit undesirable effects of the non-benign application. In some embodiments, the server processor may be configured to notify the client computing devices by generating and sending notification messages via secure a communication channel.

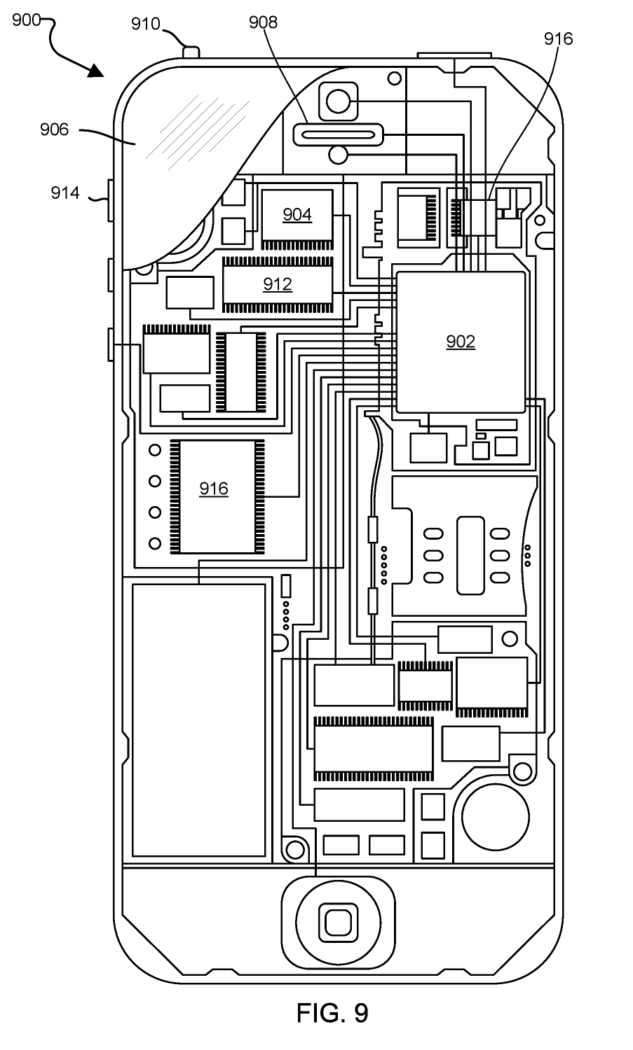

The various embodiments may be implemented on a variety of mobile client computing devices, an example of which is illustrated in FIG. 9. Specifically, FIG. 9 is a system block diagram of a client computing device in the form of a smartphone/cell phone 900 suitable for use with any of the embodiments. The cell phone 900 may include a processor 902 coupled to internal memory 904, a display 906, and a speaker 908. Additionally, the cell phone 900 may include an antenna 910 for sending and receiving electromagnetic radiation that may be connected to a wireless data link and/or cellular telephone (or wireless) transceiver 912 coupled to the processor 902. Cell phones 900 typically also include menu selection buttons or rocker switches 914 for receiving user inputs.

A typical cell phone 900 also includes a sound encoding/decoding (CODEC) circuit 916 that digitizes sound received from a microphone into data packets suitable for wireless transmission and decodes received sound data packets to generate analog signals that are provided to the speaker 908 to generate sound. Also, one or more of the processor 902, wireless transceiver 912 and CODEC 916 may include a digital signal processor (DSP) circuit (not shown separately). The cell phone 900 may further include a ZigBee transceiver (i.e., an Institute of Electrical and Electronics Engineers (IEEE) 802.15.4 transceiver) for low-power short-range communications between wireless devices, or other similar communication circuitry (e.g., circuitry implementing the Bluetooth® or WiFi protocols, etc.).

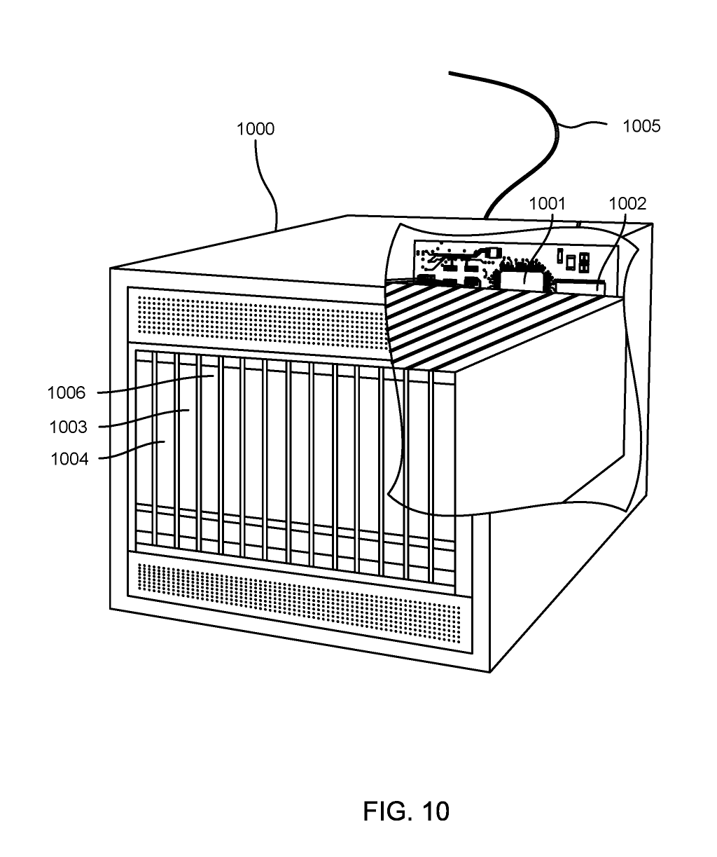

The embodiments and network servers described above may be implemented in variety of commercially available server devices, such as the server 1000 illustrated in FIG. 10. Such a server 1000 typically includes a processor 1001 coupled to volatile memory 1002 and a large capacity nonvolatile memory, such as a disk drive 1003. The server 1000 may also include a floppy disc drive, compact disc (CD) or DVD disc drive 1004 coupled to the processor 1001. The server 1000 may also include network access ports 1006 coupled to the processor 1001 for establishing data connections with a network 1005, such as a local area network coupled to other communication system computers and servers.

The processors 902, 1001, may be any programmable microprocessor, microcomputer or multiple processor chip or chips that can be configured by software instructions (applications) to perform a variety of functions, including the functions of the various embodiments described below. In some client computing devices, multiple processors 902 may be provided, such as one processor dedicated to wireless communication functions and one processor dedicated to running other applications. Typically, software applications may be stored in the internal memory 904, 1002, before they are accessed and loaded into the processor 902, 1001. The processor 902 may include internal memory sufficient to store the application software instructions. In some servers, the processor 1001 may include internal memory sufficient to store the application software instructions. In some devices, the secure memory may be in a separate memory chip coupled to the processor 1001. The internal memory 904, 1002 may be a volatile or nonvolatile memory, such as flash memory, or a mixture of both. For the purposes of this description, a general reference to memory refers to all memory accessible by the processor 902, 1001, including internal memory 904, 1002, removable memory plugged into the device, and memory within the processor 902, 1001 itself.

Modern computing devices enable their users to download and execute a variety of software applications from application download services (e.g., Apple App Store, Windows Store, Google play, etc.) or the Internet. Many of these applications are susceptible to and/or contain malware, adware, bugs, or other non-benign elements. As a result, downloading and executing these applications on a computing device may degrade the performance of the corporate network and/or the computing devices. Therefore, it is important to ensure that only benign applications are downloaded into computing devices or corporate networks.

Recently, Google/Android has developed a tool called “The Monkey” that allows users to “stress-test” software applications. This tool may be run as an emulator to generate pseudo-random streams of user events (e.g., clicks, touches, gestures, etc.) and system-level events (e.g., display settings changed event, session ending event, etc.) that developers may use to stress-test software applications. While such conventional tools (e.g., The Monkey, etc.) may be useful to some extent, they are, however, unsuitable for systematic/intelligent/smart evaluation of “Apps” or software applications with rich graphical user interface typical of software applications that are designed for execution and use in mobile computing devices or other resource-constrained devices.

There are a number of limitations with conventional stress-test tools that prevent such tools from intelligently identifying malware and/or other non-benign applications before the applications are downloaded and executed on a client computing device. First, most conventional emulators are designed for execution on a desktop environment and/or for emulating software applications that are designed for execution in a desktop environment. Desktop applications (i.e., software applications that are designed for execution in a desktop environment) are developed at a much slower rate than apps (i.e., software applications that are designed primarily for execution in a mobile or resource-constrained environment). For this reason, conventional solutions typically do not include the features and functionality for evaluating applications quickly, efficiently (i.e., without using extensive processing or battery resources), or adaptively (i.e., based on real data collected in the “wild” or “field” by other mobile computing devices that execute the same or similar applications).

Further, mobile computing devices are resource constrained systems that have relatively limited processing, memory and energy resources, and these conventional solutions may require the execution of computationally-intensive processes in the mobile computing device. As such, implementing or performing these conventional solutions in a mobile computing device may have a significant negative and/or user-perceivable impact on the responsiveness, performance, or power consumption characteristics of the mobile computing device.

In addition, many conventional solutions (e.g., “The Monkey,” etc.) generate a pseudo-random streams of events that cause the software application to perform a limited number of operations. These streams may only be used to evaluate a limited number of conditions, features, or factors. Yet, modern mobile computing devices are highly configurable and complex systems, and include a large variety of conditions, factors and features that could require analysis to identify a non-benign behavior. As a result, conventional solutions such as The Monkey do not fully stress test apps or mobile computing devices applications because they cannot evaluate all the conditions, features, or factors that could require analysis in mobile computing devices. For example, The Monkey and other conventional tools do not adequately identify the presence, existence or locations of buttons, text boxes, or other electronic user input components that are displayed on the electronic display screens of mobile computing devices. As a result, these solutions cannot adequately stress test or evaluate these features (e.g., electronic user input components, etc.) to determining whether a mobile computing device application is benign or non-benign.

Further, conventional tools do not intelligently determine the number of activities or screens used by a software application or mobile computing devices, or the relative importance of individual activities or screens. In addition, conventional tools use fabricated test data (i.e., data that is determined in advance of a program's execution) to evaluative software applications, as opposed to real or live data that is collected from the use of the software application on mobile computing devices. For all these reasons, conventional tools for stress testing software applications do not adequately or fully “exercise” or stress test software applications that are designed for execution on mobile computing devices, and are otherwise not suitable for identifying non-benign applications before they are downloaded onto a corporate networks and/or before they are downloaded, installed, or executed on mobile computing devices.

The various embodiments include computing devices that are configured to overcome the above-mentioned limitations of conventional solutions, and identify non-benign applications before the applications are downloaded onto a corporate or private network and/or before the applications are downloaded and installed on a client computing device.

As used in this application, the terms “component,” “module,” “system” and the like are intended to include a computer-related entity, such as, but not limited to, hardware, firmware, a combination of hardware and software, software, or software in execution, which are configured to perform particular operations or functions. For example, a component may be, but is not limited to, a process running on a processor, a processor, an object, an executable, a thread of execution, a program, and/or a computer. By way of illustration, both an application running on a computing device and the computing device may be referred to as a component. One or more components may reside within a process and/or thread of execution and a component may be localized on one processor or core and/or distributed between two or more processors or cores. In addition, these components may execute from various non-transitory computer readable media having various instructions and/or data structures stored thereon. Components may communicate by way of local and/or remote processes, function or procedure calls, electronic signals, data packets, memory read/writes, and other known network, computer, processor, and/or process related communication methodologies.

The foregoing method descriptions and the process flow diagrams are provided merely as illustrative examples and are not intended to require or imply that the steps of the various embodiments must be performed in the order presented. As will be appreciated by one of skill in the art the order of steps in the foregoing embodiments may be performed in any order. Words such as “thereafter,” “then,” “next,” etc. are not intended to limit the order of the steps; these words are simply used to guide the reader through the description of the methods. Further, any reference to claim elements in the singular, for example, using the articles “a,” “an” or “the” is not to be construed as limiting the element to the singular.

The various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The hardware used to implement the various illustrative logics, logical blocks, modules, and circuits described in connection with the embodiments disclosed herein may be implemented or performed with a general purpose processor, a digital signal processor (DPC), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DPC and a microprocessor, a plurality of microprocessors, one or more microprocessors in conjunction with a DPC core, or any other such configuration. Alternatively, some steps or methods may be performed by circuitry that is specific to a given function.

In one or more exemplary embodiments, the functions described may be implemented in hardware, software, firmware, or any combination thereof. If implemented in software, the functions may be stored as one or more instructions or code on a non-transitory computer-readable medium or non-transitory processor-readable medium. The steps of a method or algorithm disclosed herein may be embodied in a processor-executable software module which may reside on a non-transitory computer-readable or processor-readable storage medium. Non-transitory computer-readable or processor-readable storage media may be any storage media that may be accessed by a computer or a processor. By way of example but not limitation, such non-transitory computer-readable or processor-readable media may include RAM, ROM, EEPROM, FLASH memory, CD-ROM or other optical disk storage, magnetic disk storage or other magnetic storage devices, or any other medium that may be used to store desired program code in the form of instructions or data structures and that may be accessed by a computer. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above are also included within the scope of non-transitory computer-readable and processor-readable media. Additionally, the operations of a method or algorithm may reside as one or any combination or set of codes and/or instructions on a non-transitory processor-readable medium and/or computer-readable medium, which may be incorporated into a computer program product.

The preceding description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the following claims and the principles and novel features disclosed herein.

What is claimed is:

1. A method of protecting computing devices from non-benign software applications, comprising:
receiving, by a processor in a server computing device, data collected from independent executions of different instances of the same software application on different client computing devices;
combining the received data;
using the combined data to identify unexplored code space or potential code paths for evaluation;
exercising the software application through the identified unexplored code space or identified potential code paths in a client computing device emulator to generate analysis results; and
determining whether the software application is non-benign using the generated analysis results.

2. The method of claim 1, wherein receiving data collected from independent executions of different instances of the same software application on different client computing devices comprises receiving data for multiple software applications, the method further comprising:
computing a rank value for each of the software applications; and
selecting one of the software applications for evaluation based on its corresponding rank value.

3. The method of claim 1, further comprising:
using the received data to determine, for each of a plurality of activities associated with a software application, first conditional probability distribution values for different numbers of suspicious behaviors with respect to a condition in which an activity is visited;
using the received data to determine, for each of the plurality of activities associated with the software application, second conditional probability distribution values for different numbers of suspicious behaviors with respect to a condition in which an activity is not visited;
computing a distance value based on the determined first and second conditional probability distribution values for each of a plurality of activities associated with a software application; and
selecting an activity for evaluation based on the computed distance value.

4. The method of claim 1, wherein exercising the software application through the identified unexplored code space or identified potential code paths in a client computing device emulator to generate analysis results comprises:
cycling the software application through different location and time settings via the client computing device emulator.

5. The method of claim 1, further comprising:
determining a code coverage score and/or ranking score for the software application.

6. The method of claim 1, further comprising:
determining an overall risk score for the software application.

7. The method of claim 1, further comprising:
determining whether the received data is sufficient to evaluate the software application; and
sending feedback information to the client computing devices that indicates that no additional data is needed from specific group of users in response to determining that the received data is sufficient to evaluate the software application.

8. A server computing device, comprising:
a network access port configured to communicate with client computing devices via a network; and
a processor coupled to the network access port and configured with processor-executable instructions to perform operations comprising:
receiving data collected from independent executions of different instances of the same software application on different client computing devices;
combining the received data;
using the combined data to identify unexplored code space or potential code paths for evaluation;
exercising the software application through the identified unexplored code space or identified potential code paths in a client computing device emulator to generate analysis results; and
determining whether the software application is non-benign using the generated analysis results.

9. The server computing device of claim 8, wherein the processor is configured with processor-executable instructions to perform operations such that receiving data collected from independent executions of different instances of the same software application on different client computing devices comprises receiving data for multiple software applications,
wherein the processor is configured with processor-executable instructions to perform operations further comprising:
computing a rank value for each of the software applications; and
selecting one of the software applications for evaluation based on its corresponding rank value.

10. The server computing device of claim 8, wherein the processor is configured with processor-executable instructions to perform operations further comprising:
using the received data to determine, for each of a plurality of activities associated with a software application, first conditional probability distribution values for different numbers of suspicious behaviors with respect to a condition in which an activity is visited;
using the received data to determine, for each of the plurality of activities associated with the software application, second conditional probability distribution values for different numbers of suspicious behaviors with respect to a condition in which an activity is not visited;
computing a distance value based on the determined first and second conditional probability distribution values for each of a plurality of activities associated with a software application; and
selecting an activity for evaluation based on the computed distance value.

11. The server computing device of claim 8, wherein the processor is configured with processor-executable instructions to perform operations such that exercising the software application through the identified unexplored code space or identified potential code paths in a client computing device emulator to generate analysis results comprises:
cycling the software application through different location and time settings via the client computing device emulator.

12. The server computing device of claim 8, wherein the processor is configured with processor-executable instructions to perform operations further comprising:
determining a code coverage score and/or ranking score for the software application.

13. The server computing device of claim 8, wherein the processor is configured with processor-executable instructions to perform operations further comprising:
determining an overall risk score for the software application.

14. The server computing device of claim 8, wherein the processor is configured with processor-executable instructions to perform operations further comprising:
determining whether the received data is sufficient to evaluate the software application; and
sending feedback information to the client computing devices that indicates that no additional data is needed from specific group of users in response to determining that the received data is sufficient to evaluate the software application.

15. A server computing device, comprising:
means for receiving data collected from independent executions of different instances of the same software application on different client computing devices;
means for combining the received data;
means for using the combined data to identify unexplored code space or potential code paths for evaluation;
means for exercising the software application through the identified unexplored code space or identified potential code paths in a client computing device emulator to generate analysis results; and
means for determining whether the software application is non-benign using the generated analysis results.

16. The server computing device of claim 15, wherein means for receiving data collected from independent executions of different instances of the same software application on different client computing devices comprises means for receiving data for multiple software applications, the server computing device further comprising:
means for computing a rank value for each of the software applications; and
means for selecting one of the software applications for evaluation based on its corresponding rank value.

17. The server computing device of claim 15, further comprising:
means for using the received data to determine, for each of a plurality of activities associated with a software application, first conditional probability distribution values for different numbers of suspicious behaviors with respect to a condition in which an activity is visited;
means for using the received data to determine, for each of the plurality of activities associated with the software application, second conditional probability distribution values for different numbers of suspicious behaviors with respect to a condition in which an activity is not visited;
means for computing a distance value based on the determined first and second conditional probability distribution values for each of a plurality of activities associated with a software application; and
means for selecting an activity for evaluation based on the computed distance value.

18. The server computing device of claim 15, wherein means for exercising the software application through the identified unexplored code space or identified potential code paths in a client computing device emulator to generate analysis results comprises:
means for cycling the software application through different location and time settings via the client computing device emulator.

19. The server computing device of claim 15, further comprising:
means for determining a code coverage score and/or ranking score for the software application.

20. The server computing device of claim 15, further comprising:
means for determining an overall risk score for the software application.

21. The server computing device of claim 15, further comprising
means for determining whether the received data is sufficient to evaluate the software application; and
means for sending feedback information to the client computing devices that indicates that no additional data is needed from specific group of users in response to determining that the received data is sufficient to evaluate the software application.

22. A non-transitory processor readable having stored thereon processor-executable instructions configured to cause a processor of a server computing device to perform operations comprising:
receiving data collected from independent executions of different instances of the same software application on different client computing devices;
combining the received data;
using the combined data to identify unexplored code space or potential code paths for evaluation;
exercising the software application through the identified unexplored code space or identified potential code paths in a client computing device emulator to generate analysis results; and
determining whether the software application is non-benign using the generated analysis results.

23. The non-transitory processor readable medium of claim 22, wherein the stored processor-executable instructions are configured to cause the processor of the server computing device to perform operations such that receiving data collected from independent executions of different instances of the same software application on different client computing devices comprises receiving data for multiple software applications,
wherein the stored processor-executable instructions are configured to cause the processor of the server computing device to perform operations further comprising:
computing a rank value for each of the software applications; and
selecting one of the software applications for evaluation based on its corresponding rank value.

24. The non-transitory processor readable medium of claim 22, wherein the stored processor-executable instructions are configured to cause the processor of the server computing device to perform operations further comprising:
using the received data to determine, for each of a plurality of activities associated with a software application, first conditional probability distribution values for different numbers of suspicious behaviors with respect to a condition in which an activity is visited;
using the received data to determine, for each of the plurality of activities associated with the software application, second conditional probability distribution values for different numbers of suspicious behaviors with respect to a condition in which an activity is not visited;
computing a distance value based on the determined first and second conditional probability distribution values for each of a plurality of activities associated with a software application; and
selecting an activity for evaluation based the computed distance value.

25. The non-transitory processor readable medium of claim 22, wherein the stored processor-executable instructions are configured to cause the processor of the server computing device to perform operations such that exercising the software application through the identified unexplored code space or identified potential code paths in a client computing device emulator to generate analysis results comprises:
cycling the software application through different location and time settings via the client computing device emulator.

26. The non-transitory processor readable medium of claim 22, wherein the stored processor-executable instructions are configured to cause the processor of the server computing device to perform operations further comprising:
determining a code coverage score and/or ranking score for the software application.

27. The non-transitory processor readable medium of claim 22, wherein the stored processor-executable instructions are configured to cause the processor of the server computing device to perform operations further comprising:
determining an overall risk score for the software application.

28. The non-transitory processor readable medium of claim 22, wherein the stored processor-executable instructions are configured to cause the processor of the server computing device to perform operations further comprising:
determining whether the received data is sufficient to evaluate the software application; and
sending feedback information to the client computing devices that indicates that no additional data is needed from specific group of users in response to determining that the received data is sufficient to evaluate the software application.
